(19) United States
(12) Patent Application Publication
(10) Pub. No.: US 2013/0279182 A1
(43) Pub. Date: Oct. 24, 2013

(54) LED LIGHTING DEVICE

(71) Applicant: Kips Ivo, Antwerpen (BE)

(72) Inventor: Kips Ivo, Antwerpen (BE)

(73) Assignee: Walter SPRINGAEL, Xiaogang, Ningbo (CN)

(21) Appl. No.: 13/821,416

(22) PCT Filed: Sep. 12, 2011
(86) PCT No.: PCT/EP11/65786

§ 371 Date: Mar. 7, 2013

(30) Foreign Application Priority Data
Sep. 10, 2010 (DE) 10 2010 040 579.5

(51) Int. Cl. F21K 99/00

(52) U.S. Cl. CPC F21K 9/30
USPC 362/382

(57) ABSTRACT

An illumination device (12) for accommodating an LED luminous means (70), which device has a supply region (14, 114), a light generating region (16, 116) and a base body (10, 110) extending in a longitudinal direction, wherein at least one luminous means receptacle (30, 40, 50, 130, 140, 150) having a groove (33, 43, 53, 133, 143, 153) for fixing the luminous means (70) is provided in or on the light generating region (16, 116) and wherein the supply region (16, 116) has a channel (18, 20, 64, 118, 120, 164) having a channel base (22, 122) and a side wall (24, 124).

The above mentioned invention relates to a lighting device for attaching a LED light source featuring an energy supply area, a light providing area and a main body.

In the past the development of lighting devices was always also guided by the light sources used. Again the construction of the lighting device used was primarily determined by the light source used to generate light.

The conventional pear shape is familiar for lighting devices which generate light by a glowing filament. A lighting device of that shape can be fitted in a space saving manner namely with a single small sized fitting. The electric connections of the filament are exiting together at one end of the lighting device. The lighting device can be fitted to the holder in different ways. The most popular way is to provide compatible threaded fittings on the socket of the lighting device and in the holder so that the lighting device can be screwed into the holder.

In addition there are so called bayonet fittings where the lighting device features a radially protruding pin on its socket. In this version of the lighting device receiving voids are arranged in the holder to receive the pins. To use this, the light device is first pressed into the holder and then turned so that the pin is concealed in the holder and the lighting device is secured in the holder.

Further there are also lighting devices in this basic design which are fixed into the holder by external means.

Likewise it is known that the filament can be installed in a cylindrically shaped glass hollow body together with a gas mixture, especially with lighting devices which feature a long filament and a special gas mixture inside to protect the filament. The connections of the filament emerge from the opposite ends of the glass hollow body. Holders for these lighting devices show at least two clamps spaced apart that enclose the ends of the lighting device and in this way create an electrical connection.

Many gas discharge lighting devices, for instance fluorescent tubes, also feature a cylindrically shaped glass hollow body. Multiple electric connections in the shape of pins are provided at each end due to the more complex light generation process. The fastening on the holders for these types of lighting devices works in such a way that a slit type inlet is provided on the holders for the pins. As soon as the lighting device is installed in this slit, the lighting device is turned on its axle and fixed into the holder.

Over the last years the popularity of light emitting diodes (LEDS) in lighting device has become more significant. In order to be able to use LEDs in existing installations it is known that lighting devices with LEDS are manufactured in familiar designs and that the required converter technology is integrated into the lighting device. Therefore the previous lighting device (glowing filament, gas discharge lighting device) can be mostly replaced by LEDs without converting the available holder.

However, there are disadvantages in using LEDs in these designs since the previously existing holders and lighting devices are tuned to light generation processes used at that time.

LEDs are essentially point type light sources. As with most light applications it is known that it is customary to arrange several LEDs next to each other in one lighting device if equal illumination with less shadow casting is wanted. Provided the number of individual LEDs is large enough there is no noticeable shadow casting through this lighting device. Several LEDs are arranged on a strip shaped carrier together with the electronic control technology for the interior room lighting device whereby the carrier features an adhesive layer on its back for attaching the lighting device.

The above mentioned invention aims to provide a lighting device which takes into account the special qualities of LED light sources.

A lighting device to attach LED light source is proposed to achieve this aim which features an energy providing area, alight providing area and a main body stretching lengthwise whereby lighting device fastening means is provided with a groove in the light providing area to attach the lighting device and where the energy providing area features a channel with a channel floor and a side wall.

Since LED light sources are preferably arranged in strips in order to spread the light over as large an area as possible and to guarantee even illumination of the lit object, a lighting device fitting corresponding with the lighting device in size and shape is required. Fluorescent tubes which have a similar extension along the axis as the strip shape LED light source require only two mounting points since the glass used in the manufacturing of these provides sufficient stability. In order to achieve a similar stability it is required to equip LED light source with reinforcements. In order to attach the LED by means of a groove a corresponding flange or lug on the LED light source suffices which can then be inserted into the groove. A simple and reliable fastening of the light source to the lighting device is achieved by providing a groove. In addition less material is needed for mechanical reinforcement of the lighting device.

The channel can accept energy supply cables as well as signalising cables. Therefore it is no longer necessary to provide separate cable channels. In addition the electronic control technology for the lighting device can be accommodated in the channel. In this way, the control electronics can be installed separately from the lighting device itself so that only the defective part must be replaced on failure of the control electronics or the lighting device.

Advantageous designs of the lighting device are objects of the subclaims.

The lighting fitting can feature a contact surface for the LED light sources. The ageing of LEDs is accelerated through high operational temperatures. The heat generated by the LEDs during operation can be absorbed and discharged by the material of the lighting device fitting when the LED light source is positioned against the lighting device fitting. The operational temperature of the LEDs is reduced through this and their lifespan is increased.

The lighting device fitting features two grooves in a particularly favourable design which are arranged on opposite sides of the lighting device fitting and with their openings facing each other. In order to ensure a reliable hold of the lighting device fitting it is sufficient when the lighting device features unfitted areas on its length side which are dimensioned in such a way that they fit into the grooves. This saves material for additional flanges or lugs on the lighting device. It is now only required to slightly widen the carrier of the lighting device.

The light providing area can feature several lighting device fittings. Several LED light sources can be operated simultaneously through this in the same lighting device therewith increasing the lighting power.

Space is saved in particular when the lighting device fittings each connect on one side with each other.

The lighting device fittings can be tilted towards each other. Each LED light source has a predetermined beam angle. Additional LED light sources can be used which radiate their light in another direction than the lighting devices already available, if broader illumination is wanted than what is possible with a single light source. Therefore the lighting device can be used for different lighting device requirements. In particular the beam angle can still be adjusted easily also after installation of the lighting device.

The lighting device can feature at least one flap which features at least one reflector surface on one of the sides facing the light emission area. The beam angle can be larger than required for the actual lighting needs depending on the light means used. In order to save the light radiated outside of the necessary area it is reflected back onto the illuminated object with the help of the reflective surface. The selection of the reflecting sections controls in which areas the reflection should take place.

A lug is conveniently positioned at the opening of the channel. Different elements can be hooked onto such lugs. For instance modules with converter electronics can feature lugs and springs by which they are removably wedged between the lugs in the channel. In addition it is possible to attach cables in the channel with a similar fastening in order to obtain relief for cable tension. Likewise a securing device can be attached with a sliding profile or a clamping spring into the channel with the help of the lug so as to enable the removable fastening of the lighting device to other objects for instance ceilings and walls.

The main body can feature a module channel between the channel floor and at least one of the lighting device fittings. In this way modules such as converter electronics or other control electronics can be housed in the lighting device without requiring space for them in the channel. Thereby a better use of space in the lighting device is possible.

The main body can be manufactured from a light metal in particular from aluminum. The use of light metals enables the effective release of produced heat and keeps the weight of the lighting device down. Therefore less energy must be used for its transportation. In addition the fastening of the lighting device is made easier since the fastening elements used have to carry less weight. In addition most of the light metals are continuously cast so that a main body with an essentially continuous profile is easily manufactured for the lighting device.

The main body can feature a fastening unit for a cover. Such a cover, which protects the lighting device from unintentional mechanical influences from outside, can therefore be integrated into the lighting device. The cover not only protects the lighting device from mechanical influence from outside but also prevents the—intentional or unintentional—touching of the lighting device by persons. Injuries are also avoided through this cover since the LED light source can reach a high operational temperature.

The lighting device features a fastening device with a clamping spring and a retainer flange whereby the retainer flange is blocked by at least one lug in the assembled state. In this way a simple installation of the lighting device is possible since the fastening device can be installed separately from the lighting device. In a following step the lighting device can be plugged onto the fastening device so that the clamping spring and retainer flange snap into the lug.

The fastening device can feature a lug for loosening the connection between the fastening device and the lighting device. A simple dismantling of the lighting device is thereby ensured.

The lighting device can feature a water and dirt proof connector for connection to an energy supply. This type of connector ensures that also for outdoors applications there is no danger of electric short circuits in the lighting device connections through environmental impact.

The invention is described more closely with designs which are presented schematically in the figures. They show in:

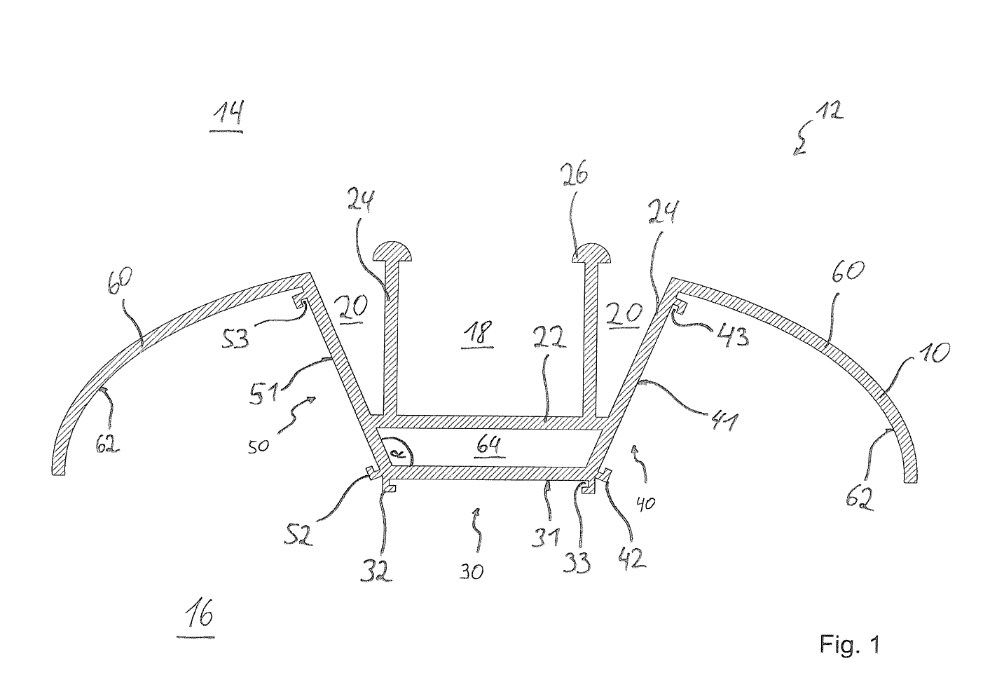

FIG. 1 a cross section through a first design of the lighting device;

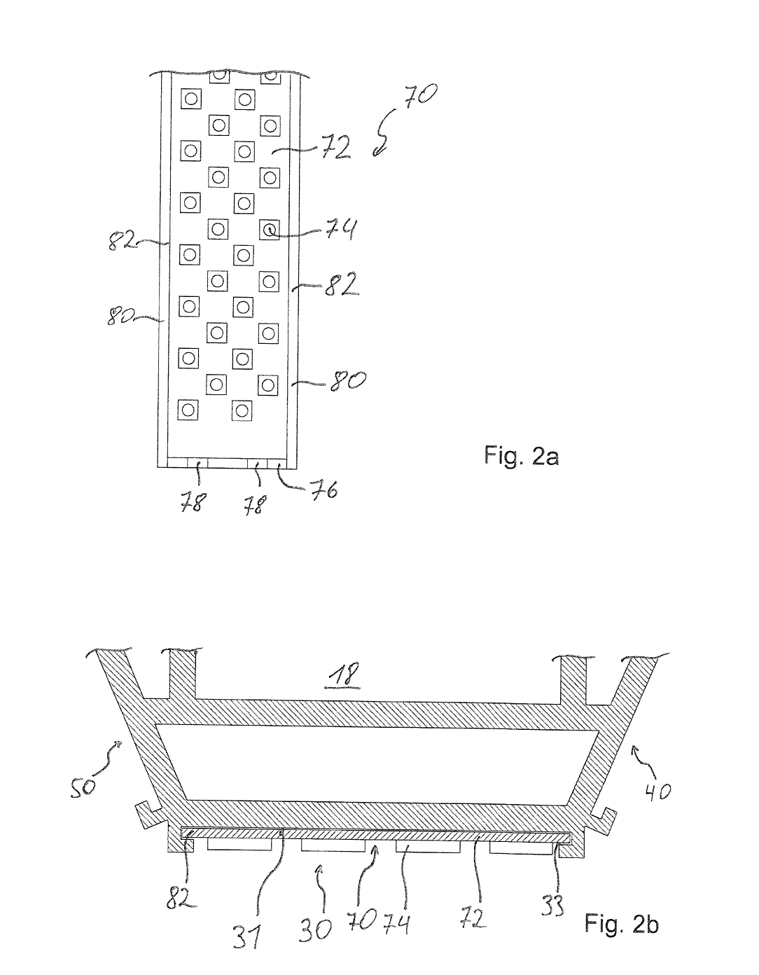

FIG. 2a a top view onto a strip shaped LED light source;

FIG. 2b a section of the cross section from FIG. 1 using an LED light source;

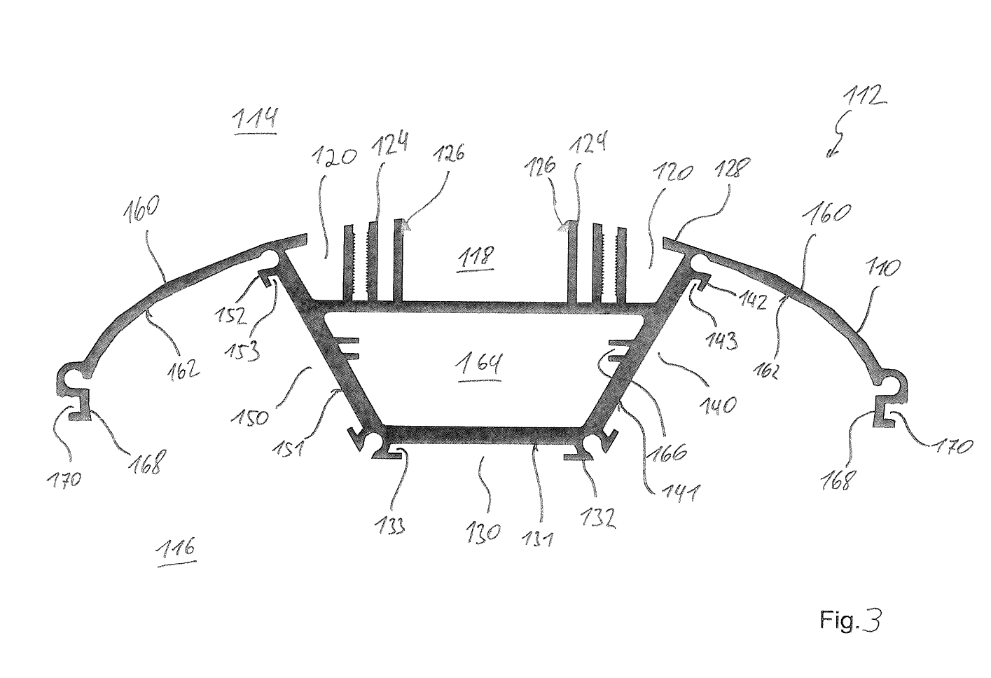

FIG. 3 a cross section through a second design of the lighting device;

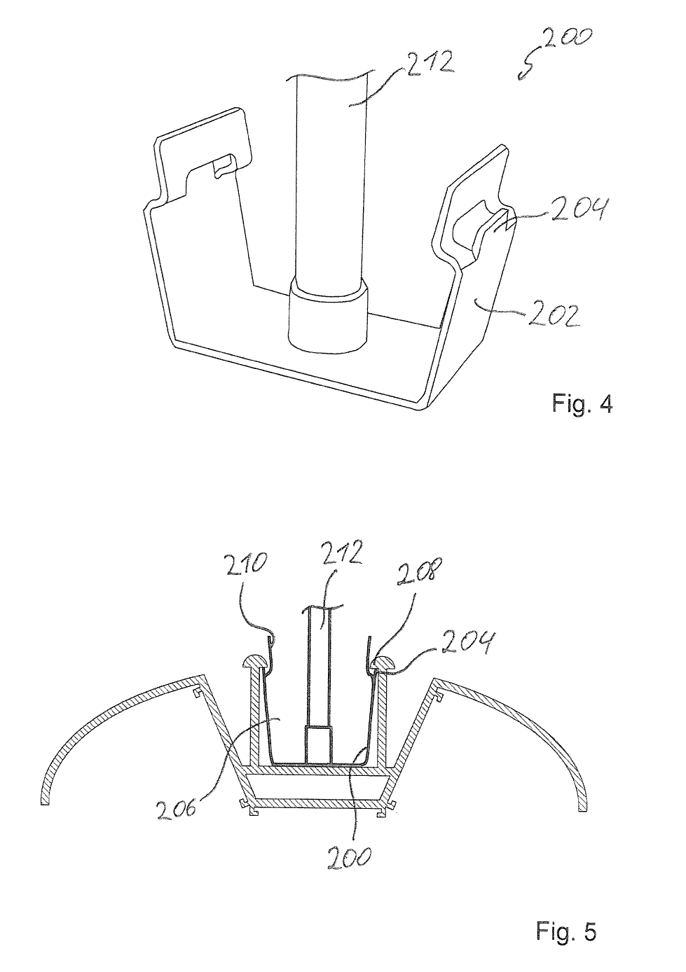

FIG. 4 a snap on unit for a channel of the lighting device;

FIG. 5 the snap on unit from FIG. 4 in latched position;

FIG. 6 a cross section through a cable connector;

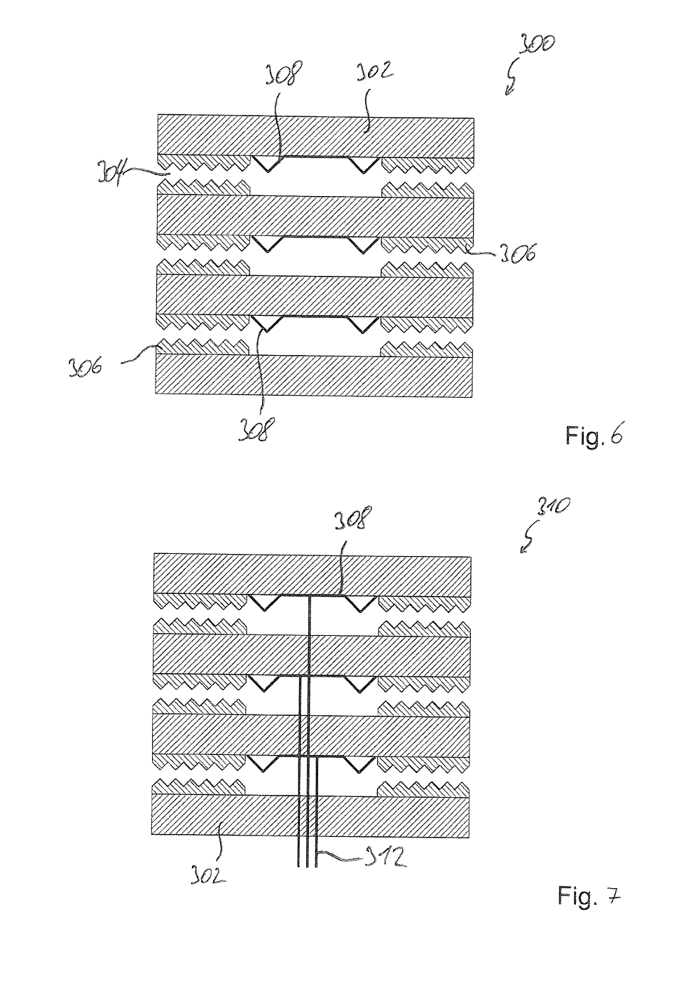

FIG. 7 a cross section as in FIG. 6 with current drain;

FIG. 8 a cross section as in FIG. 7 with inserted power cables;

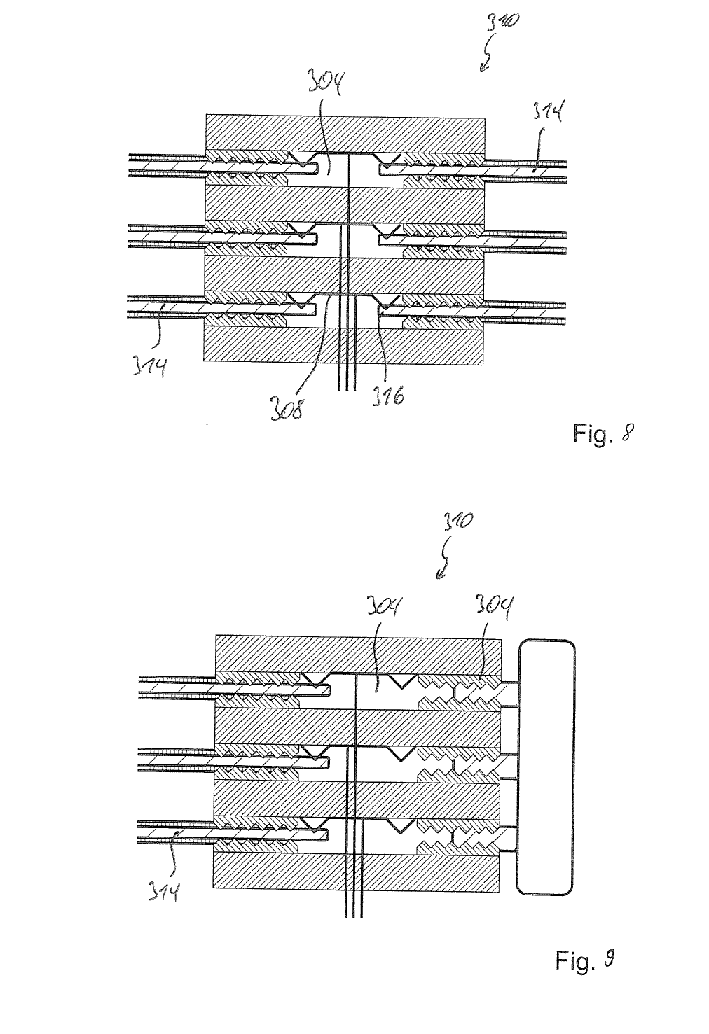

FIG. 9 a cross section as in FIG. 7 with inserted power cables, and a closing element.

The main body 10 of a first design of the lighting device 12 in accordance with the invention shown in the cross section in FIG. 1 consists of a continuous casting section which stretches lengthwise perpendicular to the drawing plane. The main body 10 features an energy supply area 14 and a light providing area 16.

The energy supply area 14 features a module channel 18 as well as two cable channels 20 in order to attach supply lines and supply devices. The channels 18, 20 feature a channel floor 22 as well as side wall 24. The cross section surface of the module channel 18 is large enough to hold a module, for instance a driver for the lighting devices.

Some of the side walls 24 feature an opening of the channels 18, 20 at the end of the lugs 26. The lugs 26 are designed in such a way that modules can be fastened onto these with snap-on units. Likewise it is possible to insert springs on this lugs which secure cables laid into the channels 18, 20.

If the main body is mounted horizontally so that the channel floor 22 stretches itself perpendicular to the gravitational force, modules and cables can be laid in the channels 18, 20 without additional fastening. Special fastening devices as well as cable tension relievers are normally necessary when the cable floor 22 shows significant bending.

In this way all the aggregates and cables required for the supply of the lighting device can be housed in the energy supply area 14.

The light providing area 16 is the area of the main body 10 which is mainly seen by an observer. Normally the main body 10 is installed in such a way that the energy supply area 14 is facing a ceiling or wall and the light providing area 16 is facing a room to be illuminated. The light providing area 16 includes means to generate light as well as to guide light.

The light providing area 16 features three lighting device fittings 30, 40, 50. Each of the lighting device fitting 30, 40, 50 has a level contact surface 31, 41, 51. The contact surfaces 41, 51 coincide in this design example with side walls 24 of the channels 18, 20. Lugs 32, 42, 52 are arranged on the long side of the contact surfaces 31, 41, 51, which are incorporated into the grooves 33, 43, 53. Essentially the lugs 33, 43, 53 run parallel to the opposite sides of the contact surfaces 31, 41, 51. The openings of grooves 33, 43, 53 are respectively aligned with each other in pairs.

A strip shaped LED light source 70 for use in a lighting device fitting 30, 40, 50 is shown in FIG. 2a. The LED light source 70 features a carrier 72 on which individual LEDs 74 are arranged. The carrier 72 features electrical connections 78 in a connector section 76 which can be connected with an energy source. Supply lines run through the carrier 72 which connect the LEDs 74 with the electric connections 78 and supply them with energy.

Fastening sections 82 are kept free along the long side 80 which can be inserted into the grooves 33, 43, 53.

As demonstrated in FIG. 2b for the lighting device fitting 30, the light source 70 is inserted for mounting into the lighting device fitting 30, 40, 50, into the grooves 33, 43, 53 so that it is held to its fastening section 82 by grooves 33, 43, 53. An additional fastening of the lighting device 70 is not required provided the main body 10 is assembled horizontally.

However, if the 1st main body 10 is bent it can be practical to fix the light source 70 with a removable fixture such as a screw in order to prevent the slipping of the light source out of lighting device fittings 30, 40, 50. Likewise it is possible to provide the long side of the light sources 70 with a friction increasing layer. This prevents the sliding of the light from its fitting, but however makes the insertion of the light source 70 more difficult. An additional fastening possibility is to provide at the end of the main body cover flaps which secure the light source 70.

When the light source 70 is installed in lighting device fittings 30, 40, 50 it lies with its back side against contact surfaces 31, 41, 51. Heat conduction is enabled between the light source 70 and the main body 10 through the contact between the light source 70 and the contact surfaces 31, 41, 51. Since light sources 70 can generate a significant amount of heat depending on the power of the light source, this heat must be diverted to prevent overheating of the light sources 70.

Furthermore the lifespan of LED light sources 70 is reduced when these are operated at elevated temperatures. The main body 10 diverts heat through contact surfaces 31, 41, 51, cooling the LED light source 70, so as to lengthen its lifespan.

The contact surface 31 runs parallel to the channel floor 22. The contact surfaces 41, 51 and also the lighting device fittings 40, 50, are facing the opposite contact surface 31 at an angle α. The size of the angle α depends on the respective lighting device task. Frequent values lie between 90° and 270°, values around 135° are especially favoured.

The main body 10 features flaps 60 adjacent to the lighting device fittings 30, 40 50 having an essentially elliptical cross section. The flap 60 features reflector surfaces 62 sides turned to the light providing area 16 and to the lighting device fittings 30, 40, 50. The reflector surfaces 62 divert light emitted from the light sources 70 installed in the lighting device fittings 30, 40, 50 into a main beam direction, in the figure the downwards direction.

In the following example a light source 70 installed in the lighting device fitting 30 mainly shines in the main beam direction. However, the light sources 70 installed in lighting device fittings 40, 50 are beaming to a considerable part in a direction deviating from this main beam direction. The beam angle of a LED light source 70 can be comparatively small. With the above mentioned design the lighting device could generate an uneven light in a room namely three bright strips with dark areas lying in between.

Through the curvature of the flaps 60 together with the reflector surfaces 62, the light coming from lighting device fittings 40, 50 is distributed resulting in a wider and more evenly distributed light.

At the same time the use of an ellipsical section should only be seen as an example of one possible flap geometry. Other curvatures can likewise achieve the same effect. It can also be desirable to concentrate the light in certain areas for particular purposes. In this case the geometry of the flap 60 must be correspondingly adapted accordingly e.g. as a hyperbolic section.

An additional module channel 64 is provided between the channel floors 22 and the lighting device fitting 30.

The main body 10 features an equal cross section over the entire length. Only openings for inputting cables or for fastening means are provided. Therefore the main body 10 can easily be manufactured through continuous casting. The additional openings specified above are then introduced following the continuous casting.

The main body 10 is manufactured from metal in order to guarantee effective heat conduction. Preferably a light metal is used in particular aluminum since this has a lower weight, thereby enabling easier fastening of the lighting device 12.

The main body 110 shown in FIG. 3 shows a similar build up as main body 10. An energy supply area 114 and a light providing area 116 are here provided too. The energy supply area 114 features a module channel 118 and two cable channels 120.

Several side walls 124 are allocated between the module channel 118 and the cable channels 120. The side walls 124 enlarge the contact surfaces with the surrounding air and also serve as cooling ribs. In addition some of the side walls are provided with roughened sections 125 which enlarge the surface of the side walls.

The module channel 118 features lugs 126 for attaching clamping springs. In addition the cable channels 120 are provided with lugs 128 which should simplify the laying of cables in the cable channels 120.

The main body 110 is provided with three lighting device fittings 130, 140, 150 with grooves 133,143,153 incorporated into the lugs 132,142,152. A module channel 164 is located between the channel floor 122 and lighting device fittings 130, 140, 150. The module channel 164 features fastening grooves 166 for holding fastening sections of modules.

In addition flaps 160 are positioned on the lighting device fittings 140,150 which feature reflector surfaces turned towards the light providing area 116. Fastening grooves 170 are positioned at the ends 168 of the flaps 160 which hold a transparent cover. This cover protects the light providing area 116 against mechanical damage. Fortunately the cover lets through light. The fastening grooves 170 allow easier fastening of the cover since this can be easily slipped into the fastening grooves 170. No further fastening of the cover is necessary provided the friction between the cover and fastening grooves 170 is sufficiently high.

The main body 110 features fastening openings 172. A cover can be attached onto the front of the main body 110 with the help of fastening openings 172. A thread can be cut in the fastening openings 172 in the front of the main body. Likewise it is possible to use screws which cut their own threads. In addition attachment with the help of splay springs is possible.

To guarantee improved heat conduction the main bodies 10, 110 are designed in one piece. However, it is possible to assemble the main body 10,110 from several individual parts if needed. Therefore it is possible to fasten the flap 60, 160 removably so that it can only be used when it is of advantage to the purpose of the lighting device.

In addition it is possible to provide a detachable hinge type connection between the middle lighting device fitting 30, 130 and the lighting device fittings 40, 50, 140, 150 so that the angle α can be set according to the respective requirements.

A fastening device 200 as shown in FIG. 4 serves to fasten the main body 10, 110 to e.g. a wall or a ceiling. The fastening device 200 features a clamping spring 202 which can be installed in the module channel 18,118. The clamping spring 202 features a retainer flange 204 which is placed in on the lug 26,126 when engaged

A fastening device 200 is shown in FIG. 5 which is installed in a channel. The retainer flange 204 sits on the lugs 208 of the channel 206 so that the fastening device 200 is firmly wedged in the channel 206. Joint bars 210, which extend over the edge of channel 206, can remove the fastening device 200 from the channel 206. To that end the joint bars 210 are pressed so closely together that the retainer flange 204 is no longer held back by the lugs 208.

The fastening device 200 features a pipe 212 which is securely connected with the clamp spring 202. The pipe 212 leads to a ceiling or wall to which it is fastened.

Thereby it is possible to attach the comparatively lightweight fastening device 200 first and to fasten the lighting device 12, 112 to the fastening device afterwards.

Several lighting devices 12, 112 are normally connected in parallel to an energy supply. It is thereby not required to insert an own energy supply line for each lighting device 12, 112. Rather a single cable is passed along the lighting devices 12, 112 and interrupted in a connection point on the required connection points. These connection points must be sufficiently dense in particular with outside installations in order to prevent short circuits as a result of penetrating dirt and moisture. In addition it is particularly expensive to change these connection points when the installation is regularly changed.

Therefore a connector 300 is proposed to connect energy supply lines as specified in FIG. 6. The connector 300 features four insulation layers 302 between which three energy modules 304 are arranged. The number of insulation layers 302 and energy modules are adapted to the number of phases and additional cables used.

The line inputs 304 feature sealing and holding clamps 306 at their exits. The sealing and holding clamps 306 serve to hold an inserted electrical cable by its isolation and to seal it off.

Bridging contacts 308 are arranged inside the energy module 304 which should be in contact and connected with the insulated ends of electrical cables in order to connect them.

If a lighting device 12, 112 must be connected to a connection point a connector 310 shown in FIG. 7 is used. The connector 310 differs from the connector 300 in that wires 312 are connected with the bridging contacts 308 which are suitable for connecting a lighting device 12, 112. The wires 312 are inserted through the insulation layers 302 whereby the wires 312 are sealed through the insulation layer 300 on the transmission points to protect against water and dirt.

FIG. 8 shows a connector 310 into which electric cables 314 are inserted into the line insertion 304 ends from both sides. The electric cables 314 are insulated at their ends 316 so that the ends 316 are connected electrically to the bridging contacts 308.

It is also possible to create a cable termination with connectors 300, 310. To this end a sealing plug 318 is used on one side of the connector 300, 310 instead of the electric cables 314 which protect the line insertion 304 from water and dirt.

The sealing plug 318 features a body 320 as well as sealing taps 322. The sealing taps 322 are manufactured from a flexible material which is pressed together by sealing and holding clamps 306 and together with these provides a water and dirt resistant connection.

It is possible to install the grooves 33, 43, 53,133,143,153 not lengthwise but in a direction perpendicular to that direction. The grooves 33, 43, 53,133,143,153 would then not be incorporated into the lugs 32, 42, 52, 132, 142, 152 but into contact surfaces 31, 41, 51, 131, 141, 151. If fastening devices such as dovetail devices are installed on the back side of the carrier 72 the grooves 33, 43, 53, 133, 143, 153 can likewise be incorporated into the contact surfaces 31, 41, 51, 131, 141, 151. with the lighting device 10, 110 according to the invention It is possible to optimally take advantage of the lighting device qualities of LEDs 74. In addition supply lines can be transported and protected in the main bodies 12, 112 so that an additional installation outside of the lighting device is not required.

The lighting devices 10, 110 enable the fitting of different lighting device fittings with LED light sources 70 according to the purpose of the lighting device and thereby to change the beam characteristics of the lighting device 10, 110. It is possible to replace defective converters or drivers without having to replace LED light sources 70 and the other way round since the control electronics (driver) is designed separately from the light sources 70. In this way, unnecessary waste is avoided and the running costs of the lighting device are reduced.

List of Reference Drawings

10 Main body
12 Lighting device
14 Energy supply area
16 Light providing area
18 Module channel
20 Cable channel
22 Channel floor
24 Side wall
26 Lug
40, 50 Lighting device fitting
41, 51 Contact surface
42, 52 Lug
43, 53 Groove 60 Flap
62 Reflector surface
64 Module channel
70 Light source
72 Carrier
74 LED
76 Connector section
78 Electric connection
80 Length side
82 Fastening section
110 Main body
114 Energy supply area
116 Light providing area
118 Module channel
120 Cable channel
122 Channel floor
124 Side wall
125 Roughened section
126 Lug
128 Lug
130, 140, 150 Lighting device fitting
131, 141, 151 Contact surface
132, 142, 152 Lug
133, 143, 153 Groove
160 Flap
162 Reflector surface
164 Module channel
166 Fastening groove
168 End
170 Fastening groove
172 Fastening opening
200 Fastening device
202 Clamping spring
204 Retainer flange
206 Channel
208 Lug
210 Joint bar
212 Pipe
300 Connector
302 Insulation layer
304 Energy module
306 Sealing and holding clamps
308 Bridging contact
310 Connector
312 Wire
314 Electric Cable
316 End
318 Sealing plug
320 Body
322 Sealing tap
α Angle

1-14. (canceled)

15. A lighting device for holding a LED light source, which features an energy providing area, a light providing area and a main body stretching lengthwise, wherein at least one lighting device fitting is provided in or on the light providing area with a groove to attach the light sources and wherein the energy providing area features a channel with a channel floor and a side wall.

16. The lighting device according to claim 15 wherein the lighting device fitting features a contact surface for the LED light source.

17. The lighting device according to claim 15 wherein at least one lighting device fitting features two grooves which are arranged on opposite sides of the lighting device fitting and of which the openings face each other.

18. The lighting device according to claim 15 wherein the light providing area features several lighting device fittings.

19. The lighting device according to claim 18 wherein the lighting device fittings each connect on one side with each other.

20. The lighting device according to claim 18 wherein the lighting device fittings are inclined towards each other at an angle (α).

21. The lighting device according to claim 15 wherein the lighting device features at least one flap which at least partly features a reflector surface on the side directed towards the light providing area.

22. The lighting device according to claim 15 wherein the channel features a lug at one opening.

23. The lighting device according to claim 15 wherein the main body features a module channel between the channel floor and at least one of the lighting device fittings.

24. The lighting device according to claim 15 wherein the main body is manufactured from a lightweight metal, in particular from aluminum.

25. The lighting device according to claim 15 wherein the main body features fastening devices for a cover.

26. The lighting device according to claim 25 wherein the fastening devices feature a clamping spring and a retainer flange, whereby the retainer flange is blocked in mounted state by at least one lug.

27. The lighting device according to claim 26, wherein the fastening devices feature a joint bar on the clamping spring for releasing the connection between the fastening device and the lighting device.

28. The lighting device according to claim 15 wherein the lighting device features a water and dirt resistant connector for connection to a power grid.
